(19) United States
(12) Patent Application Publication
(10) Pub. No.: US 2013/0068313 A1
(43) Pub. Date: Mar. 21, 2013

(54) Electronic Pressure Independent Controller For Fluid Flow Control Valve

(71) Applicants: Fred Albert George, Easton, CT (US); Brian J. O'Rourke, Watertown, CT (US); Lee D. Scott, New Fairfield, CT (US)

(72) Inventors: Fred Albert George, Easton, CT (US); Brian J. O'Rourke, Watertown, CT (US); Lee D. Scott, New Fairfield, CT (US)

(73) Assignee: Accutrol, LLC, Monroe, CT (US)

(21) Appl. No.: 13/238,155

(22) Filed: Sep. 21, 2011

(51) Int. Cl. F16K 31/02

(52) U.S. Cl. 137/14; 137/487.5

(57) ABSTRACT

A flow valve with an integral pressure-independent fluid flow controller for controlling the flow of fluid and corresponding methods for controlling fluid flow are provided. The flow valve comprises a valve body, one or more valve blades arranged on the valve body for controlling fluid flow in a duct section, an actuator for modulating the one or more valve blades, a flow sensor or sensors for sensing fluid flow, a tuning calculation module adapted for determining or monitoring a pressure drop across the valve body and for calculating tuning constants based on the pressure drop, and a controller for controlling the actuator based on a difference between a fluid flow setpoint and the sensed fluid flow in accordance with the tuning constants. The pressure drop may be determined from an algorithm based on blade position and sensed fluid flow, or may be directly measured.

### BACKGROUND OF THE INVENTION

The present invention relates to a flow valve with an integral flow controller for controlling the flow of fluid (in gaseous or liquid form) and corresponding methods for controlling fluid flow. In particular, the present invention relates to a multi-valve valve which divides a section of a duct into at least two flow sections, with a valve blade provided for controlling the fluid flow in each of the flow sections, but is also applicable to a single blade valve or any combination of duct sections with modulating blades. The present invention also provides corresponding methods for controlling fluid flow in stable manner as the static pressure in the system varies based on the system loading. The present invention is suitable for controlling airflow in a ventilation system, but can easily be applied to any type of fluid flow system, whether gaseous or liquid.

Air delivery and distribution systems are used for heating, ventilation, and cooling requirements in residential and commercial structures. These systems typically consist of a variety of types and sizes of airflow ducts used to direct air to or from various locations. It is desirable in such airflow systems to be able to accurately control and regulate the airflow in the ductwork. Airflow control and regulation is typically carried out by an adjustable damper or valve, which may be controlled using airflow sensors in the ductwork to provide feedback to the controller.

One such prior art device is the venturi valve, such as the venturi valve manufactured by Phoenix Controls Corporation of Acton, Massachusetts. Such venturi valves utilize a duct section in the shape of a venturi. The valve utilizes a cone which rides on a shaft. The shaft is attached to a spring having a constant (K) which is designed to maintain a constant airflow for a given shaft position regardless of changes in static pressure in the duct. The valve is typically designed to operate in a pressure independent manner between 0.6″ and 3.0″ water column differential pressure across the valve. The shaft can be modulated to vary the flow while the spring/cone slides on the shaft to maintain its pressure independence. The valve does not directly measure airflow; rather it is calibrated in the factory over numerous points resulting in a relatively accurate flow control. The valve can be modulated using either a pneumatic or electric actuator. An advantage of this mechanical system is that it does not have a Proportional/Integral/Derivative (PID) control loop and therefore it does not need to be tuned by field technicians for each installation. The major disadvantage of this system is that there is no measurement of airflow and therefore there is no way to know if it is operating properly after the initial installation. This system is also very susceptible to errors caused by dirty environments such as laboratory exhaust systems.

Another example of a prior art valve mechanism is the Pneumavalve manufactured by Tek-Air Systems Inc. of Danbury, Conn. The Pneumavalve utilizes a series of EPDM

(Ethylene-Propylene-Diene Monomer) bladders that are surrounded by sheet metal and spaced approximately 1″ apart in a metal casing. A 1-10 psi control signal inflates the bladders so that they restrict airflow in a duct. This valve can be manufactured from either stainless steel or galvanized steel/aluminum depending on the application. The valve is not by itself pressure independent and must be used in conjunction with an airflow sensor and an airflow controller in order to be pressure independent. This controller must contain a Proportional/Integral/Derivative (PID) control loop which accepts the airflow signal and modulates the valve position to adjust for changes in duct static pressure to maintain the desired airflow rate. Due to varying conditions in the duct, such as variations in static pressure, the PID control loop must be manually tuned for each installation. This tuning of the control loop requires expertise and time at the installation site to ensure proper operation of the control loop to ensure that the system responds quickly enough without oscillation. This time and expertise adds cost to the installation and startup of the system.

A further example of a prior art damper system is a Variable Air Volume (VAV) terminal box. There are numerous manufacturers of VAV terminal boxes including but not limited to Titus of Richardson, Tex., Anemostat of Carson, California, Krueger of Richardson, Tex., Tuttle & Bailey of Richardson, Tex., and Price Industries of Suwanee, Ga. A VAV terminal box is simply a cylindrical section of sheet metal with a round blade on a shaft in the duct section. The blade is rotated throughout a 90 degree arc to vary the flow in a duct. Such blade dampers are not linear devices, so accurate control of airflow is very limited. When the device is moving from fully closed to open there is initially a relatively large change in airflow versus control signal and the reverse happens when the valve moves from fully closed to open. This type of product is relatively inexpensive and is predominately used for temperature control where speed and accuracy is not important. This product is not pressure independent in itself and requires a separate controller to accept the airflow signal and compare that signal to a setpoint and utilizes a PID control loop to send a signal to the valve to modulate it to maintain the desired airflow. This controller must contain a Proportional/Integral/Derivative (PID) control loop which accepts the airflow signal and modulates the valve position to adjust for changes in duct static pressure to maintain the desired airflow rate. Due to varying conditions in the duct, such as variations in static pressure, the PID control loop must be manually tuned for each installation. This tuning of the control loop requires expertise and time at the installation site to ensure proper operation of the control loop to ensure that the system responds quickly enough without oscillation. This is even more difficult and time consuming with this type of product due to its nonlinear characteristics. This time and expertise adds cost to the installation and startup of the system.

Another prior art device is the blade damper. There are numerous manufacturers of blade dampers including but not limited to Titus of Richardson, Tex., Anemostat of Carson, Calif., Krueger of Richardson, Tex., Tuttle & Bailey of Richardson, Tex., and Price Industries of Suwanee, Ga. This product is simply a cylindrical section of sheet metal with a round blade on a shaft in the duct section. The blade is rotated throughout a 90 degree arc to vary the flow in a duct. Such blade dampers are not linear devices, so accurate control of airflow is very limited. When the blade is modulated from fully closed to open there is initially a relatively large change in airflow versus control signal and the reverse happens when the blade is modulated from fully open to closed. This type product is relatively inexpensive and is predominately used for temperature control where speed and accuracy is not important. This product is not pressure independent in itself and requires a separate controller to accept the airflow signal and compare that signal to a setpoint and utilizes a PID control loop to send a signal to the valve to modulate it to maintain the desired airflow. Due to varying conditions in the duct, such as the differing ranges of static pressure in the duct, the PID control loop must be manually tuned for each installation. This tuning of the control loop requires expertise and time at the installation site to ensure proper operation of the control loop to ensure that the system responds quickly enough without oscillation. This is even more difficult and time consuming with this type of product due to its nonlinear characteristics. This time and expertise adds cost to the installation and startup of the system.

The above-described prior art has numerous shortcomings. All of the prior art devices described above require a secondary device such as an airflow controller to be pressure independent and that controller must be manually configured via adjustable Proportional Integral Derivative (PID) tuning constants based on the installation to control airflow in a stable manner.

The venturi valve does not require a secondary device such as an airflow controller to maintain stable control of airflow as duct pressure changes. Instead it uses a complex mechanical assembly to maintain its pressure independence. The venturi valve is a complicated device with numerous levers, springs and a cone that must ride smoothly on a shaft for the accuracy to be maintained. Being a mechanical device it is very susceptible to dust and dirt in an airstream and can easily be contaminated, seriously affecting its accuracy.

Therefore, in order to overcome the aforementioned difficulties associated with the prior art, it would be advantageous to provide a device that is designed to provide efficient and reliable fluid flow modulation, that is independent of pressure changes in the duct and which does not rely on mechanical systems in order to achieve its pressure independence. It would also be advantageous to provide a product which has this pressure independence with a built in controller and for that controller to electronically adjust for changes in pressure without the need for manually setting the tuning constants. This gives the device pressure independence over a wide fluid flow and static pressure range with minimal setup requirements by technicians. It would also be advantageous for this product to provide a reading of the position of the blades so that it could be used in a building management system to optimize the system by running at the lowest possible duct static pressure while maintaining stable fluid flow control in each duct branch.

The methods and apparatus of present invention provide the foregoing and other advantages.

### SUMMARY OF THE INVENTION

The present invention relates to a flow valve with an integral pressure-independent flow controller for controlling the flow of fluid and corresponding methods for controlling fluid flow.

In accordance with an example embodiment of the invention, a flow valve with an integrated pressure-independent flow controller is provided. The flow valve comprises a valve body, one or more valve blades arranged on the valve body for controlling fluid flow in a duct or pipe section, an actuator for modulating the one or more valve blades, one or more flow sensors for sensing fluid flow, a tuning calculation module adapted for determining or monitoring a pressure drop across the valve body and for calculating tuning constants based on the pressure drop, and a controller for controlling the actuator based on a difference between a flow setpoint and the sensed fluid flow in accordance with the tuning constants.

In one example embodiment, the flow valve may further comprise a position sensor for sensing a position of either the actuator or the one or more valve blades. The tuning calculation module may be further adapted for receiving a fluid flow signal from the flow sensor, receiving a position signal from the position sensor, and determining the pressure drop based on the fluid flow signal and the position signal.

For example, the position sensor may sense the position of the actuator. In such a case, the position of the actuator corresponds to a known position of the one or more valve blades. Alternatively, the position sensor may sense the position of the one or more valve blades. In such an example embodiment, the position sensor may comprise a potentiometer, a Hall Effect sensor, or any other type of sensor suitable for sensing the position of a movable blade as would be apparent to those skilled in the art.

The tuning constants may be proportional, integral, and derivative (PID) constants. The controller may be a PID controller.

The flow sensor may comprise a vortex type sensor, a pitot type sensor, a thermal type sensor, or any other type of sensor suitable for sensing fluid flow as would be apparent to those skilled in the art.

In a further example embodiment, the flow valve may further comprise a pressure transducer for measuring the pressure drop across the flow valve and providing a pressure signal indicative of the pressure drop. In such an example embodiment, the tuning calculation module may monitor the pressure signal from the pressure transducer.

The tuning calculation module may continuously recalculate the tuning constants and provide the recalculated tuning constants to the controller.

The valve body may have a proximal end and a distal end. Further, the valve body may be adapted to separate the duct section into at least two fluid flow sections. The one or more valve blades may comprise at least two valve blades mounted on the distal end of the valve body, each of the valve blades controlling fluid flow in a respective fluid flow section of the duct section. At least one of the proximal end and the distal end of the valve body may have an aerodynamic shape. A flow sensor may be arranged in each fluid flow section.

A method for controlling fluid flow in a duct section may also be provided in accordance with the present invention. In one example embodiment, such a method may comprise providing a flow valve comprising a valve body and one or more valve blades arranged on the valve body for controlling fluid flow in a duct section, providing an actuator for modulating the one or more valve blades, sensing fluid flow in the duct section, determining or monitoring a pressure drop across the valve body, calculating tuning constants based on the pressure drop, and controlling the actuator based on a difference between a fluid flow setpoint and the sensed fluid flow in accordance with the tuning constants.

In one example embodiment, the method may further comprise sensing a position of either the actuator or the one or more valve blades. In such an embodiment, the pressure drop may be determined based on the fluid flow signal and the sensed position. For example, the position of the actuator may be sensed, where the position of the actuator corresponds to a known position of the one or more valve blades. Alternatively, the position of the one or more valve blades may be sensed.

In a further example embodiment, the method may further comprise measuring the pressure drop across the valve body, providing a pressure signal indicative of the pressure drop, and monitoring the pressure signal.

The method may also include additional features discussed above in connection with the various embodiments of the fluid flow valve.

### BRIEF DESCRIPTION OF THE DRAWINGS

The present invention will hereinafter be described in conjunction with the appended drawing figures, wherein like reference numerals denote like elements, and:

FIG. 1 shows a cutaway view of a duct section with an example of a prior art airflow control valve installation.

FIG. 2 shows a cutaway view of a duct section with an example embodiment of a fluid flow valve installed in accordance with the present invention;

FIG. 3 shows a block diagram of a first example embodiment of the present invention;

FIG. 4 shows a block diagram of a second example embodiment of the present invention; and

FIG. 5 shows a block diagram of a third example embodiment of the present invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

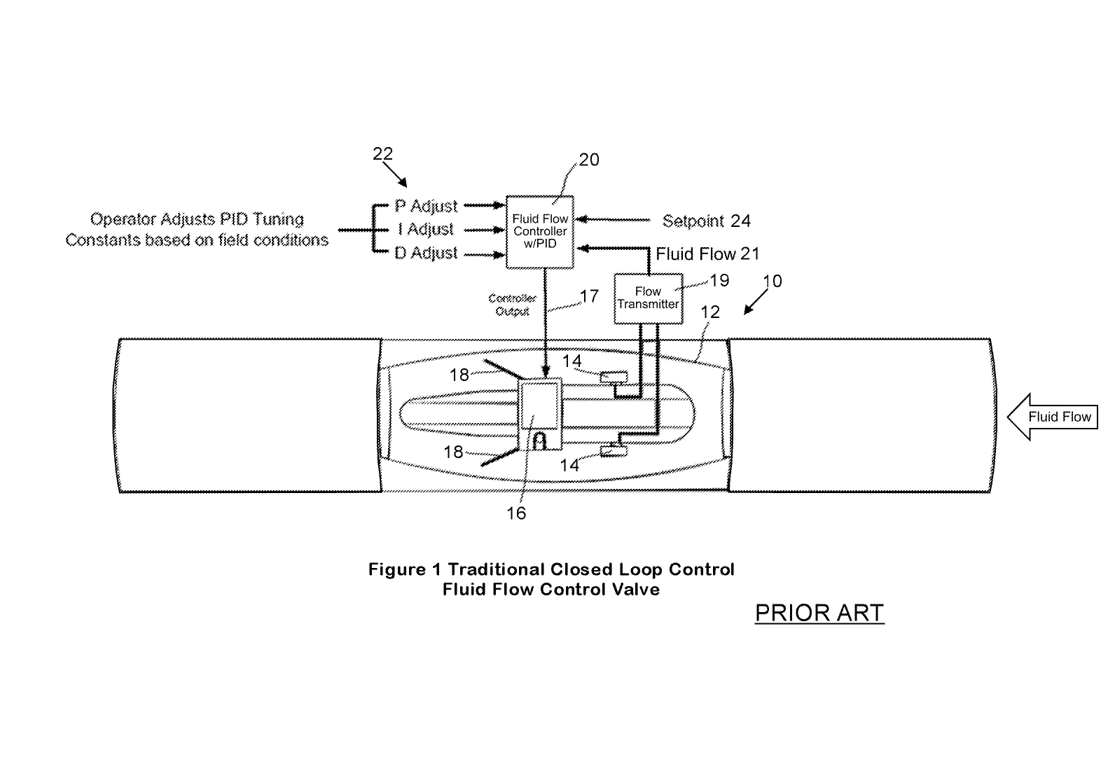

FIG. 1 shows a cutaway view of a duct section 10 with an example of a prior art airflow control valve 12 installed therein. The prior art example shows a valve which bifurcates the duct section 10 with airflow sensors 14 installed within the valve 12 and an electronic actuator 16 used to modulate valve blades 18 in response to a control signal 17 from a controller 20 (e.g., a PID controller). A flow transmitter 19 provides an airflow signal 21 from the sensors 14 to the controller 20. In order for the closed loop airflow control valve 12 to provide fast and stable control of the airflow it is necessary to manually “tune” the controller 20. In such a traditional control valve 12 as shown in FIG. 1, tuning the controller 20 consists of a field engineer or technician manually adjusting the tuning constants 22 (e.g., PID constants) while the system is in operation until the control response is as fast as required while maintaining stable airflow control without overshooting an airflow setpoint 24.

The present invention provides a fluid flow valve for controlling fluid flow with in integral controller which provides closed loop control responsive to a pressure differential across a valve body of the flow valve, thereby allowing stable flow control without the need for onsite tuning the control parameters when the product is installed in different duct configurations. The present invention would allow the valve with electronic pressure independent control to be installed in applications like fume hood exhaust duct and for it to receive a fluid flow setpoint and to control fluid flow in a stable manner without operator intervention regardless of changes in the duct pressure.

The fluid may be a gas or a liquid. For example, the fluid may be air, water, or any other gas or liquid in a system where precise flow control is required.

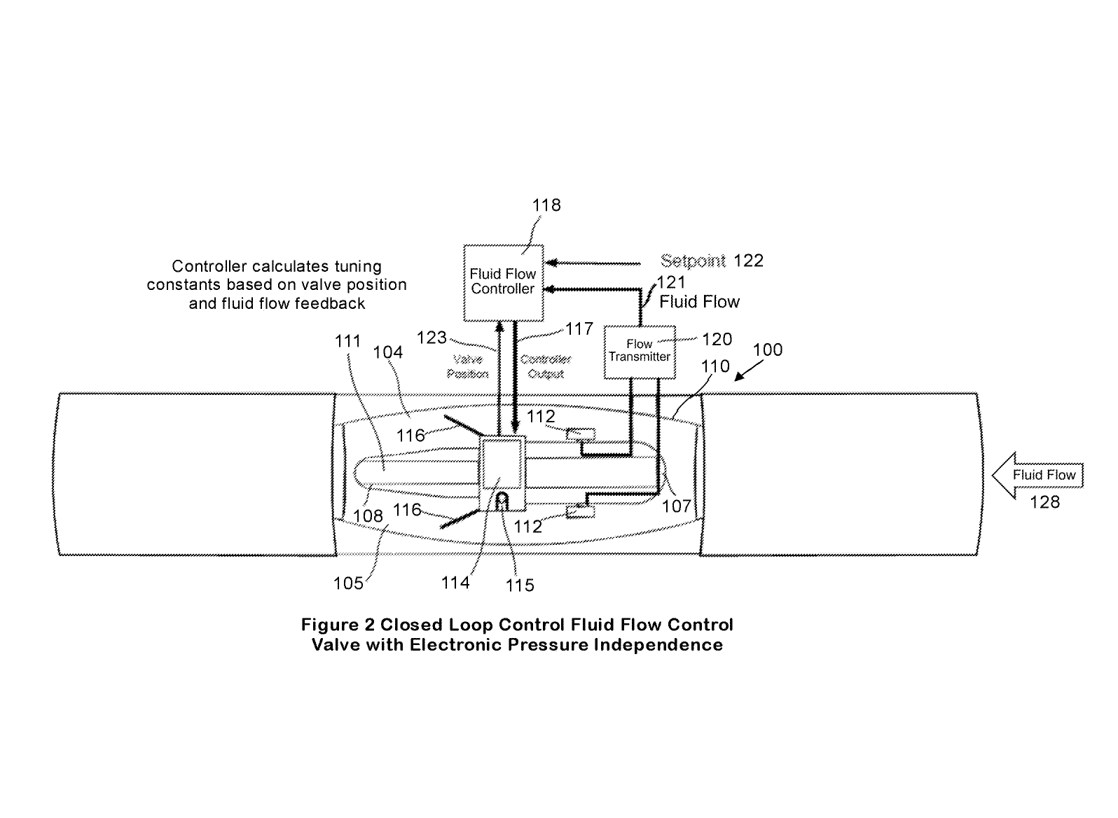

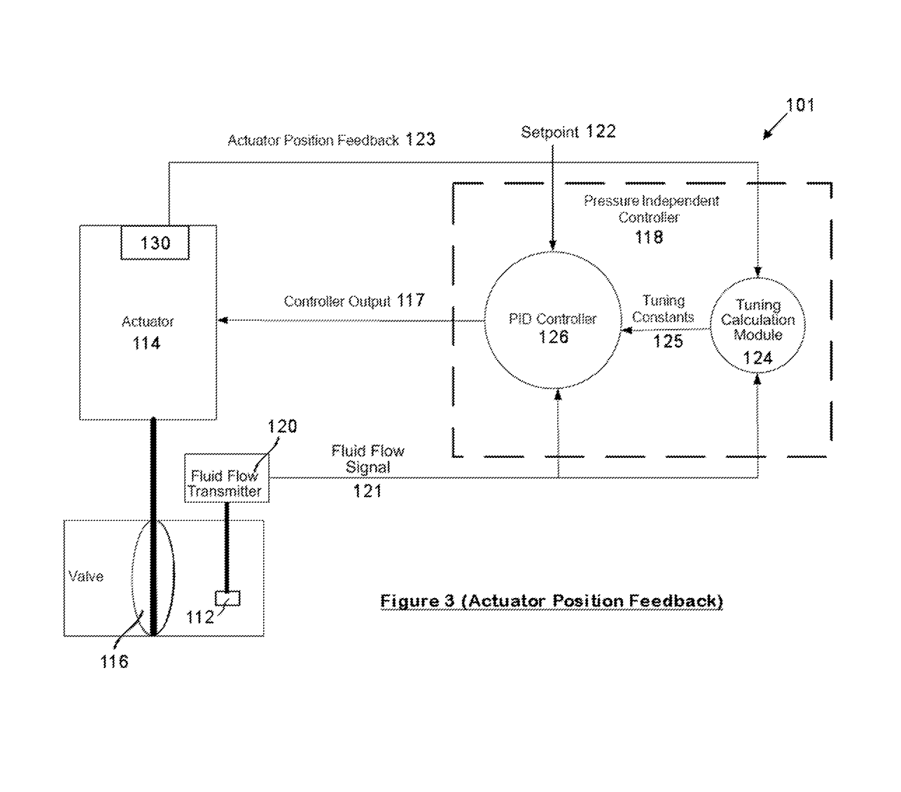

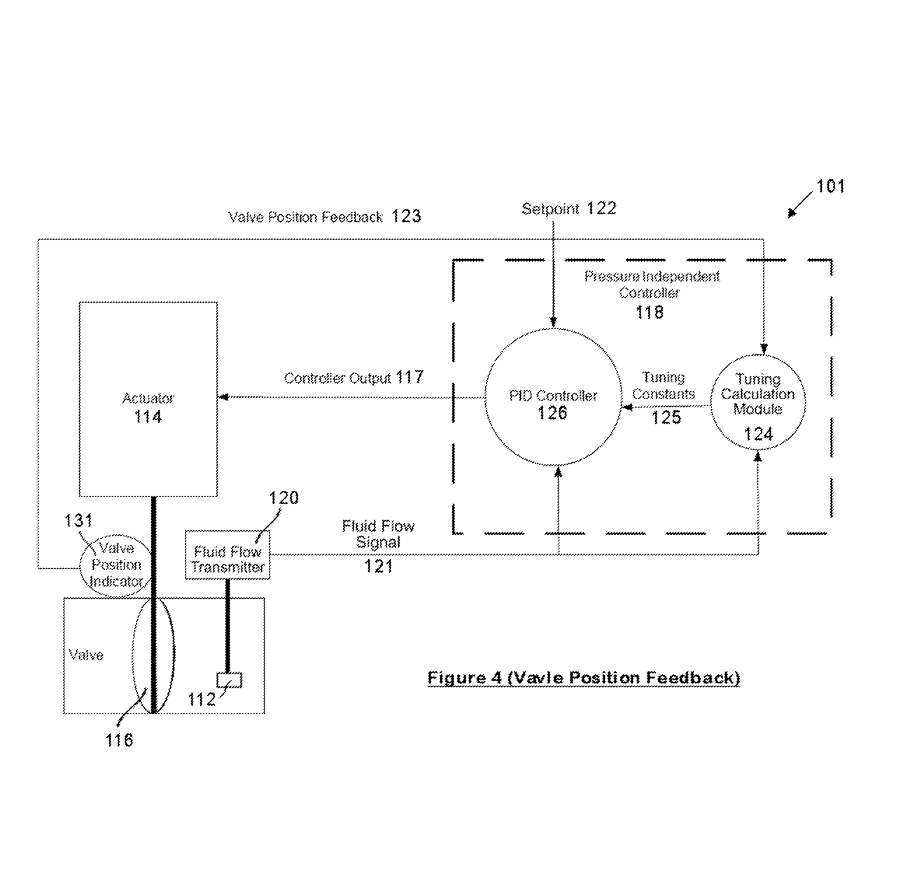

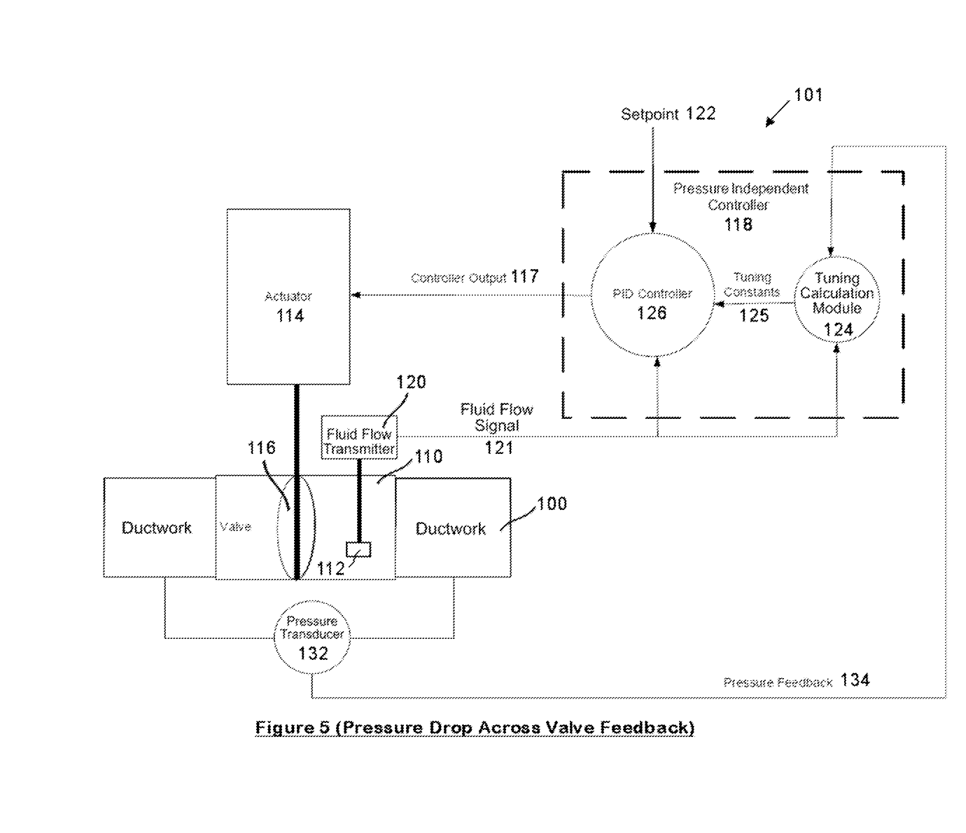

FIG. 2 shows a cutaway view of a duct section 100 with an example of a fluid flow control valve 110 in accordance with an example embodiment of the present invention. The example valve 110 is shown as having a valve body 111 which bifurcates the duct section 100. Although a bifurcated valve is shown, those skilled in the art will recognize that any flow control valve can be used to provide fluid flow control utilizing a fluid flow controller in accordance with the present invention with fluid flow feedback. Fluid flow sensors 112 are installed within the valve. An electronic actuator 114 is used to modulate one or more blades 116 in response to a control signal 117 from the controller 118. A flow transmitter 120 provides a fluid flow signal 121 from the sensors 112 to the controller 118. In order for the closed loop fluid flow control valve 110 to provide fast and stable control of the fluid flow, it is necessary to “tune” the controller 110. With the present invention, the control loop is “self-tuning”. By using the feedback of the flow sensors 112 and a calculated or monitored pressure differential across the valve body 111, a tuning calculation module (e.g., within the controller 118 and described in detail below) calculates the tuning constants required to provide fluid flow control that is as fast as required while maintaining stable fluid flow control with minimal deviation with respect to the fluid flow setpoint 122. As explained in detail below, the pressure differential may be determined based on the fluid flow signal 121 and valve blade position from a position signal 123 (as described below in connection with FIGS. 3 and 4) or from a direct reading of the pressure drop across the valve body 111 (as described in detail below in connection with the FIG. 5 embodiment). The tuning calculation module may continuously recalculate the tuning constants and provide the recalculated tuning constants to the controller.

FIGS. 3-5 show block diagrams of example embodiments of the control loop 101 for the flow valve 110 of FIG. 2 with an integrated pressure-independent fluid flow controller 118 in accordance with the present invention. The flow valve 110 comprises a valve body 111, one or more valve blades 116 arranged on the valve body 111 for controlling fluid flow in a duct section 100, an actuator 114 for modulating the one or more valve blades 116, and a fluid flow sensor 112 for sensing fluid flow. The pressure independent controller 118 comprises a tuning calculation module 124 adapted for determining or monitoring a pressure drop across the valve body 111 and for calculating tuning constants 125 based on the pressure drop, and a controller 126 (e.g., a PID controller) for controlling the actuator 114 based on a difference between a fluid flow setpoint 122 (FIG. 2) and the sensed fluid flow 121 in accordance with the tuning constants 125. The one or more flow sensors 112 provide an electrical output which represents the fluid flow 121 within the duct section 100 between 0% which is fully closed to 100% of the fluid flow which is fully open and all points in between.

In one example embodiment, the flow valve may further comprise a position sensor for sensing a position 123 of either the actuator 114 or the one or more valve blades 116. The tuning calculation module 124 may be further adapted for receiving a fluid flow signal 121 from the flow sensor 112 (e.g., via the flow transmitter 120), receiving a position signal 123 from the position sensor, and determining the pressure drop based on the fluid flow signal 121 and the position signal 123.

For example, a position sensor 130 may sense the position of the actuator 114 as shown in FIG. 3. In such a case, the position of the actuator 114 corresponds to a known position of the one or more valve blades 116. Alternatively, a position sensor 131 may sense a position of the one or more valve blades 116 as shown in the FIG. 4 embodiment. In such an example embodiment, the position sensor 131 may comprise a potentiometer, a Hall Effect sensor, or any other type of sensor suitable for sensing the position of a movable blade as would be apparent to those skilled in the art.

The tuning constants 125 may be proportional, integral, and derivative (PID) constants. The controller 126 may be a PID controller. The PID control loop accepts a fluid flow set-point input 122 (FIG. 2) and compares it to the fluid flow measurement feedback signal 121. The error between the setpoint 122 and feedback signal 121 is processed by the PID controller 126, which calculates an output signal 117 that will reduce the error. The output signal 117 drives the valve actuator 114 which modulates the blades 116 to provide the fluid flow required based on the setpoint 122 provided to the controller 118 for closed loop fluid flow control.

The controller 126 requires different tuning constants 125 to maintain stable control of the required fluid flow based on the actual installation of the valve 110 in the duct section 100. One item that has a major effect on the tuning constants 125 is the pressure differential across the valve body 111. As the pressure differential across the valve changes, the tuning calculation module determines the optimum tuning constants. In the example embodiment shown in FIGS. 3 and 4, the pressure differential across the valve body 111 (FIG. 2) in the duct section is determined via the evaluation of the fluid flow and the valve position. In the example embodiment shown in FIG. 3, the valve position 123 is determined by feedback from the actuator 114 which provides a separate signal representing the position of the blade(s) 116. The actuator 114 would provide an electrical output 123 which represents the valve position between 0% which is fully closed to 100% of the fluid flow which is fully open and all points in between.

In the example embodiment shown in FIG. 4, the valve position 123 is determined by direct measurement of the position of the blade(s) 116 using a potentiometer, Hall Effect sensor or any other sensor which would measure the blade position. In this embodiment, the sensor 131 would provide an electrical output which represents the valve position between 0% which is fully closed to 100% of the fluid flow which is fully open and all points in between.

In either embodiment shown in FIGS. 3 and 4, using the fluid flow signal 121 and valve position feedback signal 123, the tuning calculation module 124 determines the pressure differential across the valve body 111 in the duct section 100. Once the pressure differential is determined, the tuning calculation module 124 calculates the required tuning constants 125 (e.g., PID constants) to maintain high speed and stable control of the fluid flow. The tuning calculation module 124 continually monitors the fluid flow and blade position and updates the tuning constants 125 as required.

The flow sensor(s) 112 may comprise a vortex type sensor, a pitot type sensor, a thermal type sensor, or any other type of sensor suitable for sensing fluid flow as would be apparent to those skilled in the art.

In a further example embodiment as shown in FIG. 5, the flow valve 110 may further comprise a pressure transducer 132 for directly measuring the pressure drop across the flow valve 110 and providing a pressure signal 134 indicative of the pressure drop. In such an example embodiment, the tuning calculation module 124 may monitor the pressure signal 134 from the pressure transducer 132. The pressure transducer 132 would provide an electrical output 134 which represents the pressure differential between 0″ we and 100% of the pressure differential and all points in between. Using the fluid flow signal 121 and pressure differential feedback signal 134, the tuning calculation module 124 is able to calculate the required tuning constants 125 to maintain high speed and stable control of the fluid flow. The tuning calculation module 124 continually monitors the fluid flow 121 and pressure differential 134 and updates the tuning constants 125 for the controller 126 as required.

As shown in FIG. 2, the valve body 111 may have a proximal end 107 and a distal end 108. Further, the valve body 111 may be adapted to separate the duct section into at least two fluid flow sections 104, 105. The one or more valve blades 116 may comprise at least two valve blades mounted on the distal end 108 of the valve body 111, each of the valve blades 116 controlling fluid flow in a respective flow section 104, 105 of the duct section 100. The at least two valve blades 116 may be modulated with one actuator 114 utilizing linkage 115 which modulates the blades 116 at different rates to maintain a linear action of control input to fluid flow output. The actuator 114 used may be a rotary actuator attached to one of the blades as the driver blade and the linkage connected thereto drives the remaining blade or blades as follower blade(s). The position sensor (130 or 131) may provide feedback to the controller 118, and the tuning calculation module 124 in the controller 18 will use that feedback in conjunction with the fluid flow measurement 121 in an algorithm for each type and size of valve to determine the pressure differential in the duct section. The pressure differential will be derived via this unique algorithm which is based on the relationship between the measured fluid flow, valve position and optionally valve size. Alternatively as discussed above in connection with FIG. 5, the pressure differential may be measured directly. Once the pressure differential is derived or measured, specific tuning constants (e.g., Proportional, Integral and Derivative tuning constants) will be applied to the controller 118 which are calculated from the fluid flow and pressure algorithm to provide optimum control and response to the fluid flow setpoint 122 throughout the range of the flow control valve.

At least one of the proximal end 107 and the distal end 108 of the valve body 111 may have an aerodynamic shape to minimize the pressure drop across the valve body 111. A flow sensor 112 may be arranged in each fluid flow section.

While the drawings show a dual chamber valve, those skilled in the art of fluid flow control will appreciate that the control mechanism of present invention may be utilized in connection with any type of fluid flow valve.

It should now be appreciated that the present invention provides advantageous methods and apparatus for closed loop pressure-independent fluid flow control without the need for manually adjusting tuning constants.

Although the invention has been described in connection with various illustrated embodiments, numerous modifications and adaptations may be made thereto without departing from the spirit and scope of the invention as set forth in the claims.

What is claimed is:

1. Fluid flow valve with an integrated pressure-independent flow controller, comprising:
a valve body;
one or more valve blades arranged on the valve body for controlling fluid flow in a duct section;
an actuator for modulating the one or more valve blades;
a flow sensor for sensing fluid flow;
a tuning calculation module adapted for:
determining or monitoring a pressure drop across the valve body; and
calculating tuning constants based on the pressure drop; and
a controller for controlling the actuator based on a difference between a fluid flow setpoint and the sensed fluid flow in accordance with the tuning constants.

2. Fluid flow valve in accordance with claim 1, further comprising:
a position sensor for sensing a position of one of the actuator or the one or more valve blades;
wherein the tuning calculation module is further adapted for:
receiving a fluid flow signal from the flow sensor;
receiving a position signal from the position sensor; and
determining the pressure drop based on the fluid flow signal and the position signal.

3. Fluid flow valve in accordance with claim 2, wherein the position sensor senses the position of the actuator, the position of the actuator corresponding to a known position of the one or more valve blades.

4. Fluid flow valve in accordance with claim 2, wherein the position sensor senses the position of the one or more valve blades.

5. Fluid flow valve in accordance with claim 4, wherein the position sensor comprises one of a potentiometer or a Hall Effect sensor.

6. Fluid flow valve in accordance with claim 1, wherein:
the tuning constants are proportional, integral, and derivative (PID) constants; and
the controller is a PID controller.

7. Fluid flow valve in accordance with claim 1, wherein the flow sensor comprises one of a vortex type sensor, a pitot type sensor, or a thermal type sensor.

8. Fluid flow valve in accordance with claim 1, further comprising:
a pressure transducer for measuring the pressure drop across the valve body and providing a pressure signal indicative of the pressure drop;
wherein the tuning calculation module monitors the pressure signal from the pressure transducer.

9. Fluid flow valve in accordance with claim 1, wherein the tuning calculation module continuously recalculates the tuning constants and provides the recalculated tuning constants to the controller.

10. Fluid flow valve in accordance with claim 1, wherein:
the valve body has a proximal end and a distal end;
the valve body is adapted to separate the duct section into at least two fluid flow sections;
the one or more valve blades comprises at least two valve blades mounted on the distal end of the valve body, each of the valve blades controlling fluid flow in a respective fluid flow section of the duct section; and
at least one of the proximal end and the distal end of the valve body has an aerodynamic shape.

11. Fluid flow valve in accordance with claim 10, further comprising:
a flow sensor arranged in each fluid flow section.

12. A method for controlling fluid flow in a duct section, comprising:
providing a flow valve comprising a valve body and one or more valve blades arranged on the valve body for controlling fluid flow in a duct section;
providing an actuator for modulating the one or more valve blades;
sensing fluid flow in the duct section;
determining or monitoring a pressure drop across the valve body;
calculating tuning constants based on the pressure drop; and
controlling the actuator based on a difference between a fluid flow setpoint and the sensed fluid flow in accordance with the tuning constants.

13. A method in accordance with claim 12, further comprising:
sensing a position of one of the actuator or the one or more valve blades;
wherein the pressure drop is determined based on the sensed fluid flow and the sensed position.

14. A method in accordance with claim 13, wherein the position of the actuator is sensed, the position of the actuator corresponding to a known position of the one or more valve blades.

15. A method in accordance with claim 13, wherein the position of the one or more valve blades is sensed.

16. A method in accordance with claim 12, wherein:
the tuning constants are proportional, integral, and derivative (PID) constants; and
the controller is a PID controller.

17. A method in accordance with claim 12, further comprising:
measuring the pressure drop across the valve body;
providing a pressure signal indicative of the pressure drop; and
monitoring the pressure signal.

18. A method in accordance with claim 12, wherein the tuning constants are continuously recalculated and provided to the controller.

19. A method in accordance with claim 12, wherein:
the valve body has a proximal end and a distal end,
the valve body is adapted to separate the duct section into at least two fluid flow sections;
the one or more valve blades comprises at least two valve blades mounted on the distal end of the valve body, each of the valve blades controlling fluid flow in a respective fluid flow section of the duct section; and
at least one of the proximal end and the distal end of the valve body has an aerodynamic shape.

20. A method in accordance with claim 19, wherein:
a flow sensor is arranged in each fluid flow section.
